(19) United States
(12) Patent Application Publication
(10) Pub. No.: US 2013/0227190 A1
(43) Pub. Date: Aug. 29, 2013

(54) High Data-Rate Processing System

(71) Applicant: Marc V. Berte, Ashburn, VA (US)

(72) Inventor: Marc V. Berte, Ashburn, VA (US)

(73) Assignee: RAYTHEON COMPANY, Waltham, MA (US)

(21) Appl. No.: 13/405,693

(22) Filed: Feb. 27, 2012

(51) Int. Cl. G06F 13/28

(52) U.S. Cl. 710/308

(57) ABSTRACT

A data processing system includes a hub processing portion, and a first plurality of processing resources communicatively connected to define a first ring, wherein each processing resource of the first plurality of processing resources is communicatively connected to the hub processing portion.

### BACKGROUND

The present disclosure relates generally to data processing and more specifically to processing architectures with high data-rate processing.

Processing systems often include numerous processing resources that receive packets of data and processing instructions. The processing systems may include different processing resources having different functions and capabilities. Thus, some data processing tasks may include the use of numerous processors to perform portions of the processing tasks.

The transmission of data between the processing resources may be limited by the bandwidth of the connections between the processing resources. The limitations in bandwidth may reduce the overall processing performance of the systems.

### SUMMARY

According to one embodiment of the present invention, a data processing system includes a hub processing portion having a, point-to-point data switching portion, a first processing resource having an direct memory access (DMA) data communication portion communicatively connected to the point-to-point data switching portion of the hub processing portion, a second processing resource having an DMA data communication portion communicatively connected to the point-to-point data switching portion of the hub processing portion and the DMA data communication portion of the first processing resource, a third processing resource having an DMA data communication portion communicatively connected to the point-to-point data switching portion of the hub processing portion and the DMA data communication portion of the second processing resource, and a fourth processing resource having an DMA data communication portion communicatively connected to the point-to-point data switching portion of the hub processing portion, the DMA data communication portion of the third processing resource and the DMA data communication portion of the first processing resource.

According to another embodiment of the present invention, a data processing system includes a hub processing portion, and a first plurality of processing resources communicatively connected to define a first ring, wherein each processing resource of the first plurality of processing resources is communicatively connected to the hub processing portion.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 illustrates an exemplary embodiment of a data processing system;

FIG. 2 illustrates an alternate exemplary embodiment of a data processing system;

FIG. 3 illustrates a block diagram of an exemplary embodiment of the processing resources of the system of FIG. 1;

FIG. 4 illustrates a block diagram of an exemplary embodiment of the hub processing portion of the system of FIG. 1;

FIG. 5 illustrates a block diagram of an alternate exemplary embodiment of a data processing system; and

FIG. 6 illustrates a block diagram of an exemplary embodiment of a GPU of FIG. 5.

### DETAILED DESCRIPTION

Processing capability continues to increase, and a steadily increasing number of individual and group users results in the network traffic that connects processers expanding at an ever faster rate. Some computational tasks use iterative or recursive computations that include iterative analysis at various steps in the process. Though the individual computations may not use significant processing resources, the iterative nature of the analysis uses data transfer resources, which may reduce the efficiency of the processing system due to data transfer bottlenecks. Typical data centers have a processing to data bandwidth ratio (P/D) (e.g., GFLOPS/Gwords per second) of about 1000-5000. For some processing tasks, this ratio may be too high (i.e. limited by data transfer rates) as many iterative or recursive types of computational tasks require P/D ratios of several hundred for each step (i.e. before a major branch in the computational tasking). Thus, a system that optimizes the P/D ratio for these type of tasks is described below using Peripheral Component Interconnect-express (PCIe) type switches that are arranged on system processing boards for connectivity.

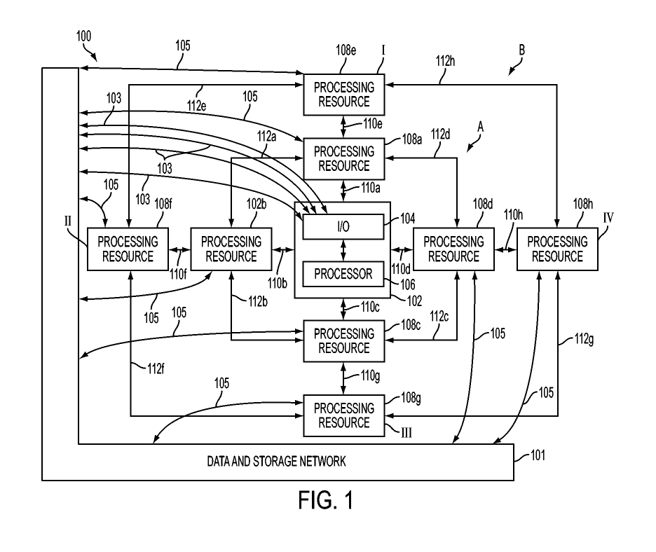

FIG. 1 illustrates an exemplary embodiment of a data processing system (system) 100. The system 100 includes a hub processor element 102 that includes an input/output (I/O) portion 104 and a processing portion 106. The I/O portion 104 may include for example, one or more communications boards having I/O processing features and connectors. The processing portion 106 may include one or more processors that are communicatively connected to each other and to the I/O portion 104. The I/O portion is communicatively connected to a data and storage network 101 via connections 103 that may include, for example, 10G Ethernet®, 40G Etherenet®, or high speed InfiniBand® connections. In the illustrated embodiment, the processing portion 106 includes two processing boards each with a Peripheral Component Interconnect-express PCIe type switch that provides communicative connections 110a-d directly (i.e. with direct memory access) between the processors and peripheral devices of the processing boards. The PCIe of the processing portion 106 are also connected to the PCIe connections of processing resources 108a-d (via PCIe switches).

In this regard, the PCIe connections include on-motherboard closely coupled high speed point to point packet switches using multiple bi-directional high speed links (e.g., PCIe) to on-motherboard devices and to a backplane containing board-to-board physical connections of multiple of these switches. The links are of a similar type as those attaching (from an electrical and signal perspective) directly to the CPU package (e.g., PCIe) to minimize both physical and throughput overhead associated with translation from one protocol (e.g., PCIe directly connected to the CPU) to another (e.g., Ethernet from a PCIe connected network card). This arrangement allows for both the board to board connections to be referenced, connects the board to board links with the ones going to the CPU, and references other on-board devices (since the FPGA or Tilera processing elements mounted to the boards communicate to the on-board switch in a similar manner as the main CPU(s) on the board.

The processing resources 108a-d each include a processing portion that includes one or more processing elements and a PCIe type switch that provides a communicative connection to the PCIe connections of the processing portion 106, and an another processing resource 108 that is communicatively arranged in a “ring A” defined by the processing resources 108a-d and the connections between the processing resources 108a-d. In this regard, the PCIe switches of each processing resource 108a-d is connected to the PCIe switches of two other processing resources 108a-d in the ring via the connections 112a-d, which are communicative connections between PCIe type switches. The processing resources 108e-h are similar to the processing resources 108a-d, and are communicatively arranged in a “ring B.” Each of the processing resources 108e-h is connected to the PCIe switches of three other processing resources 108 via on-board PCIe type switches. In this regard, the ring B includes the processing resources 108e-h and the communicative connections 112e-h. Each of the processing resources 108e-h is connected to one of the processing resources 108a-d via PCIe type switches by connections 110e-h. Each of the processing resources 108 is communicatively connected to the data and storage network 101 via connections 105 that may include, for example, 10G Ethernet®, 40G Etherenet®, or high speed InfiniBand® connections.

The processing resources 108 define “branches” that are defined by communicative connections arranged in series from the hub processor element 102. In this regard, a branch I is defined by the connection 110a, the processing resource 108a, the connection 110e and the processing resource 108e. The branch II is defined by the connection 110b, the processing resource 108b, the connection 110f and the processing resource 108f. The branch III is defined by the connection 110c, the processing resource 108c, the connection 110d and the processing resource 108d. The branch IV is defined by the connection 110d, the processing resource 108d, the connection 110h and the processing resource 108h.

The connections 110 and 112 provide data flow paths between processing resources 108 and between the processing resources 108 and the hub processor element 102. For example, the hub processor element 102 may receive a processing task via a connection 103 and the data and storage network 101. The hub processor element 102 may perform some processing of the processing task and send the task or portions of the task to the processing resource 108d. The processing resource may perform a processing task and send the results and a related processing task to the processing resource 108f via any available transmission path (e.g., connection 112d; processing resource 108a; connection 110e; processing resource 108e; connection 112e; and via the data and storage network 101). The processing resource 108f may send output to the data network and SAN 101 via a connection 105, or may send the output to the hub processor element 102 that may send the output to the data and storage network via a connection 103, or may perform or direct additional processing via a processing resource 108.

The topological configurations described herein allows for a minimization of bottlenecks of data flows since each of the connections are approximately similar speeds. Such an arrangement achieves high efficiency for data processing tasks that involve significant data transfer and iterative or recursive aspects. In this regard, the processing resources 108 may not be identical or similar, for example, the processing resource 108a may be optimized for one type of processing (e.g., a graphical processing unit(s) for mathematical matrix computations), while the processing resource 108b may be optimized for another type of processing (e.g., a field programmable gate array(s) for digital signal processing tasks). Thus, the systems described herein allow for data to be moved efficiently between processing resources 108 such that a processing resource 108 that is optimized or designed to efficiently perform a particular processing task may efficiently receive the data and perform the task rather than retaining the data at a processing resource 108 that is less efficient with regard to a particular desired processing task.

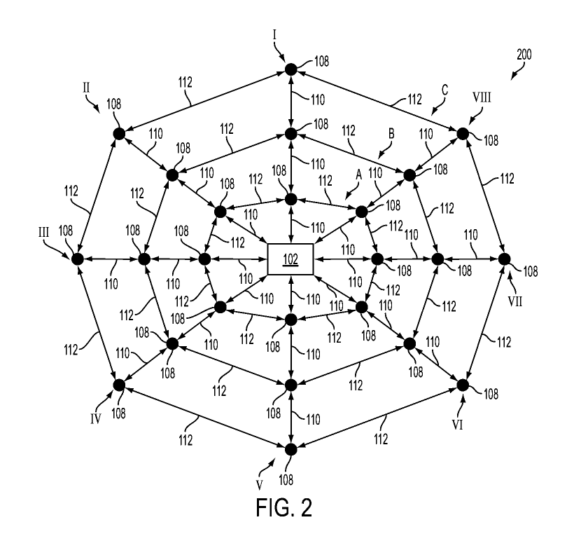

The connections 110 and 112 of the illustrated exemplary embodiment include 8 GB/s (total bidirectional peak theoretical rate on each of the links, e.g., 112a may be 8 GB/s and 112b may be 8 GB/s) data flow rates, however any suitable data flow rate may be used to increase the efficiency of the system 100. Any number of additional “rings” and branches may be added to increase the processing capabilities of the system without reducing the data flow rate between elements. In this regard, FIG. 2 illustrates an alternate exemplary embodiment of a system 200 that includes a hub processing portion 102 and three rings (A-C) and eight branches (I-VIII) of processing resources 108 (processing nodes) that are connected by connections 110 and 112 between PCIe switches in a similar manner as described above. As additional rings are added, additional branches may be added to maintain the data flow rates between the processing resources 108 and the hub processing portion 102.

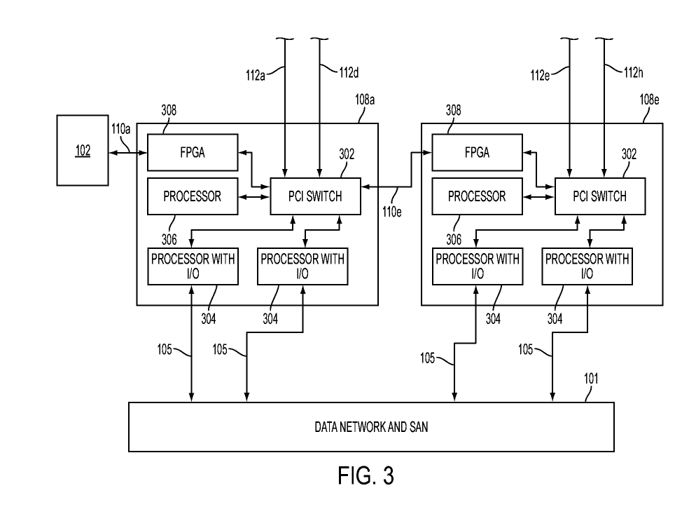

FIG. 3 illustrates a block diagram of an exemplary embodiment of the processing resources 108a and 108e of the system 100 (of FIG. 1). Each of the processing resources 108 includes a PCIe type switch portion 302, processor portions with I/O connections 304, a processor portion 306, and a field programmable gate array (FPGA) portion 308; each of which are connected to the PCIe type switch portion 302.

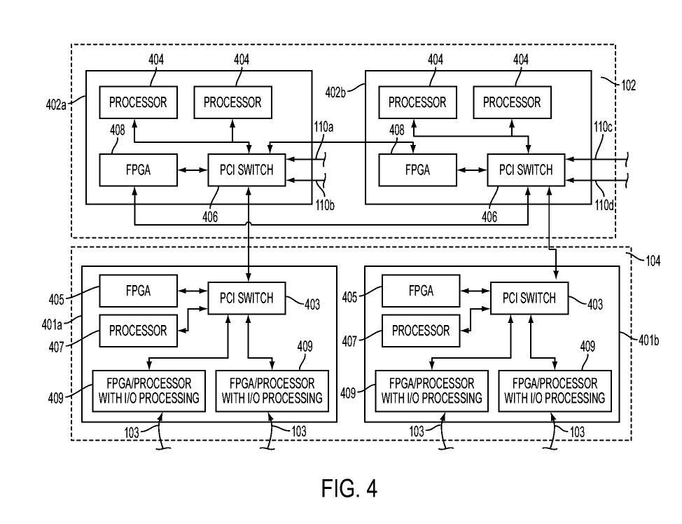

FIG. 4 illustrates a block diagram of an exemplary embodiment of the hub processing portion 102. The hub processing portion includes the I/O portion 104 and the processing arrangement portion 106. The processing arrangement portion 106 includes a first processing component 402a and a second processing component 402b that each include processing elements 404 that have PCIe connections that are communicatively connected to a PCIe type switch portion 406 in addition to a separate connection directly between the two processing elements on a single board. The processing components 402a and b include FPGA portions 408 that are communicatively connected to the PCI type switch portion 406. The FPGA portions 408 may include, for example firmware to effect the PCIe root complex address translation (i.e. implementation of a PCIe non-transparent bridge). Such firmware enables this configuration to operate similar to a meshed network rather than a master with an array of slave devices which would have more limited data exchange capability and greater overhead. In this regard, each element is its own root complex and element to element connections are provided through switches. For example, processing resource 108f communicating with processing resource 108d may use the switch on processing resource 108a. If processing resource 108a is communicating with the processing resource 108g at the same time, the processing resource 108a-108d link would be used twice.

The I/O portion 104 includes a first I/O component 401a and a second I/O component 401b that each include a PCIe type switch 403 that is communicatively connected to a FPGA portion 405, a processing element 407, and I/O elements 409 that may include, for example, FPGAs and/or an additional processor that performs I/O or other types of processing.

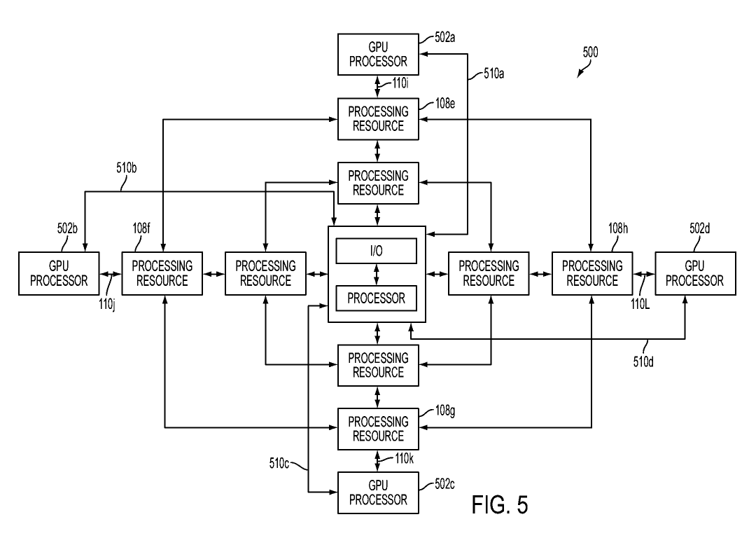

FIG. 5 illustrates a block diagram of an alternate exemplary embodiment of a data processing system 500, the system 500 is similar to the system 100 (of FIG. 1) described above and includes graphics processing units (GPU) 502a-d that are communicatively connected to the PCIe connections of corresponding processing resources 108e-h with PCIe type switches via connections 110i-L. The GPU units 502a-d may also be connected to the PCIe connections of the hub processor element 102 with PCIe type switches via connections 510a-d.

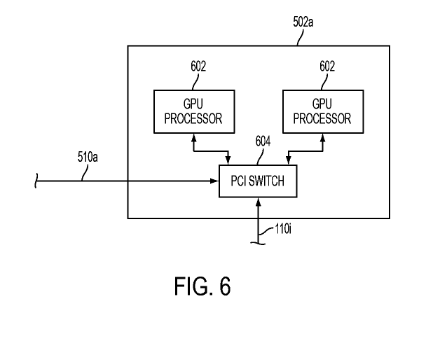

FIG. 6 illustrates a block diagram of an exemplary embodiment of a GPU 502a. In this regard, the GPU 502a includes GPU processing elements 602 that are communicatively connected to a PCIe type switch 604.

Though the illustrated embodiments described above include PCIe type switches, that may include, for example, any type of PCIe device capable of implementing multiple point-to-point data paths and provide packet-switched data exchange between these paths, alternate embodiments may include any other types of switching devices and/or connection physical links, protocols, and methods that facilitate connections between the direct (i.e. not through a chipset based IO controller) data paths of processing elements.

While the disclosure has been described with reference to a preferred embodiment or embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A data processing system comprising:
a hub processing portion having a, point-to-point data switching portion;
a first processing resource having an direct memory access (DMA) data communication portion communicatively connected to the point-to-point data switching portion of the hub processing portion;
a second processing resource having an DMA data communication portion communicatively connected to the point-to-point data switching portion of the hub processing portion and the DMA data communication portion of the first processing resource;
a third processing resource having an DMA data communication portion communicatively connected to the point-to-point data switching portion of the hub processing portion and the DMA data communication portion of the second processing resource; and
a fourth processing resource having an DMA data communication portion communicatively connected to the point-to-point data switching portion of the hub processing portion, the DMA data communication portion of the third processing resource and the DMA data communication portion of the first processing resource.

2. The system of claim 1, further comprising:
a fifth processing resource having an DMA data communication portion communicatively connected to the DMA data communication portion of the first processing resource;
a sixth processing resource having an DMA data communication portion communicatively connected to the DMA data communication portion of the second processing resource and the DMA data communication portion of the fifth processing resource;
a seventh processing resource having an DMA data communication portion communicatively connected to the DMA data communication portion of the third processing resource and the DMA data communication portion of the sixth processing resource; and
an eighth processing resource having an DMA data communication portion communicatively connected to the DMA data communication portion of the fourth processing resource, the DMA data communication portion of the seventh processing resource and the DMA data communication portion of the fifth processing resource.

3. The system of claim 1, wherein each of the DMA data communication portions are connected via a peripheral component interconnect-express (PCIe) switch portion.

4. The system of claim 1, wherein the hub processing portion includes an input/output (I/O) portion communicatively connected to a data network.

5. The system of claim 1, wherein the first processing resource is communicatively connected to a data network with a first communicative link, the second processing resource is communicatively connected to a data network with a second communicative link, the third processing resource is communicatively connected to a data network with a third communicative link, and the fourth processing resource is communicatively connected to a data network with a fourth communicative link.

6. The system of claim 2, wherein the fifth processing resource is communicatively connected to a data network with a fifth communicative link, the sixth processing resource is communicatively connected to a data network with a sixth communicative link, the seventh processing resource is communicatively connected to a data network with a seventh communicative link, and the eighth processing resource is communicatively connected to a data network with a eighth communicative link.

7. The system of claim 1, wherein the hub processing portion comprises:
an I/O portion having a plurality of I/O processing elements communicatively connected to a first PCIe switch; and
and a processing arrangement portion having a processing element communicatively connected to a second PCIe switch, the second PCIe switch communicatively connected to the first PCIe switch.

8. The system of claim 1, wherein each of the processing resources includes a processing element and an I/O element communicatively connected to a PCIe switch.

9. The system of claim 1, further comprising:
a first graphics processing unit (GPU) portion communicatively connected through a PCIe switch to the PCIe switch portion of the fifth processing resource and the PCIe switch portion of the hub processing portion;
a second GPU portion communicatively connected through a PCIe switch to the PCIe switch portion of the sixth processing resource and the PCIe switch portion of the hub processing portion;
a third GPU portion communicatively connected through a PCIe switch to the PCIe switch portion of the seventh processing resource and the PCIe switch portion of the hub processing portion; and
a fourth GPU portion communicatively connected through a PCIe switch to the PCIe switch portion of the eighth processing resource and the PCIe switch portion of the hub processing portion.

10. A data processing system comprising:
a hub processing portion; and
a first plurality of processing resources communicatively connected to define a first ring, wherein each processing resource of the first plurality of processing resources is communicatively connected to the hub processing portion.

11. The system of claim 10, further comprising a second plurality of processing resources communicatively connected to define a second ring, wherein each processing resource of the second plurality of processing resources is communicatively connected to a corresponding processing resource of the first plurality of processing resources.

12. The system of claim 10, further comprising a third plurality of processing resources communicatively connected to define a third ring, wherein each processing resource of the third plurality of processing resources is communicatively connected to a corresponding processing resources of the second plurality of processing resources.

13. The system of claim 10, wherein the first plurality of processing resources communicatively connected to define the first ring are connected via PCIe switch portions of the processing resources of the first plurality of processing resources, and each processing resource of the first plurality of processing resources is communicatively connected to a PCIe switch portion of the hub processing portion via the PCIe switch portions of the processing resources of the first plurality of processing resources.

14. The system of claim 11, wherein the second plurality of processing resources communicatively connected to define the second ring are connected via PCIe switch portions of the processing resources of the second plurality of processing resources, and each processing resource of the second plurality of processing resources is communicatively connected to the corresponding processing resource of the first plurality of processing resources via the PCIe switch portions of the processing resources of the second plurality of processing resources and the PCIe switch portions of the corresponding processing resources of the first plurality of processing resources.

15. The system of claim 12, wherein the third plurality of processing resources communicatively connected to define the third ring are connected via PCIe switch portions of the processing resources of the third plurality of processing resources, and each processing resource of the third plurality of processing resources is communicatively connected to the corresponding processing resource of the second plurality of processing resources via the PCIe switch portions of the processing resources of the third plurality of processing resources and the PCIe switch portions of the corresponding processing resources of the second plurality of processing resources.

16. The system of claim 11, further comprising a plurality of graphics processing units (GPUs), wherein each GPU of the plurality of GPUs is communicatively connected to a corresponding processing resource of the third plurality of processing resources.

17. The system of claim 16, wherein each GPU of the plurality of GPUs is communicatively connected to the hub processing portion.

18. The system of claim 10, wherein the hub processing portion is communicatively connected to a data network.

19. The system of claim 10 wherein each processing resource of the first plurality of processing resources is communicatively connected to a data network.

20. The system of claim 11, wherein each processing resource of the second plurality of processing resources is communicatively connected to a data network.
